(19) United States
(12) Patent Application Publication
(10) Pub. No.: US 2022/0061275 A1
(43) Pub. Date: Mar. 3, 2022

(54) ECOLOGICAL CULTURE METHOD FOR FISH THAT CONTAINS MARINE BARRACUDA

(71) Applicant: Jiangsu Academy of Agricultural Sciences, Nanjing City (CN)

(72) Inventors: Shiqun Han, Nanjing City (CN); Shaohua Yan, Nanjing City (CN); Qing Zhou, Nanjing City (CN)

(21) Appl. No.: 17/009,931

(22) Filed: Sep. 2, 2020

(51) Int. Cl. A01K 61/10; A01K 63/04; A01K 61/85; A01K 61/95; A23K 50/80; A23K 10/18; A23K 10/30; A23K 20/147; A23K 20/158; A23K 20/24; A23K 20/26; A23K 20/22

(52) U.S. Cl. CPC A01K 61/10; A01K 63/04; A01K 61/85; A01K 61/95; A23K 50/80; A23K 20/22; A23K 10/30; A23K 20/147; A23K 20/158; A23K 20/24; A23K 20/26; A23K 10/18

(57) ABSTRACT

This invention discloses an ecological culture method for fish that contains marine barracuda, which places the marine barracuda fry in natural seawater, uses circulating water to dilute the natural sea water step by step, and domesticates the marine barracuda with fresh water; when the salinity of the water body is reduced to 3‰, transferring the fry to the fish culturing pond, and then the freshwater species are introduced, and the ecological culturing and ecological poly-culture model is carried out; during the culturing period, checking the growth of barracuda, adjusting the feeding and/or feeding times, and therefore barracuda reaches the required specifications within the expected time to be on the market.

### FIELD OF THE INVENTION

The invention relates to the technical field of desalination and cultivation of marine barracuda fry, and specifically relates to an ecological culture method for fish that contains marine barracuda.

### BACKGROUND OF THE INVENTION

In the salty freshwater body of tidal-flat area that along the coast, there are many high-priced aquatic organisms, such as barracuda, which are popular with consumers. Developing the characteristic aquaculture industry of the tidal flat by the development and utilization of these aquatic organisms assists in greatly improving the economic benefits of tidal flat aquaculture industry, injecting new vitality into the development of tidal flat, and promoting the rational development and utilization of the national beach. Barracuda is a highly adaptable fish with a wide distribution and is particularly suitable for growing in the salty fresh water conditions of tidal flat embankment. Barracuda meat is delicate, delicious, rich in nutrition, and owns high economic value, additionally, is highly appreciated by the consuming public. With fast growth, big body size, mixed bleeding habit and limited disease, barracuda is known as “scavenger”, which is suitable for ecological polyculture. Mixing barracuda in the sea-coated large water pond can effectively remove the remaining bait and excreta at the bottom of the pond, make full use of the beach pond space and bait, regulate water quality, reduce the use of drugs, and improve the efficiency of culturing. Barracuda fry is originally from sea water, and there are currently artificial fries; nevertheless, the costs are high, and the market is in short supply.

Patent CN110692557A discloses a method of using artificial sea salt to desalinate the culture of little yellow croaker, and a method of gradient desalination treatment of little yellow croaker in turn; nonetheless, on the one hand, this method needs to change the growth environment of fish frequently, adversely affecting the health of fish; on the other hand, the operation process is cumbersome, multiple freshwater ponds are needed to achieve the process of fish domestication, which is not conducive to large-scale use, resulting in waste of energy and resources.

Patent CN108142329A discloses a high efficient with low sewage ecological culture method for the desalination cultivation of marine barracuda fry, and also provides a method of graded domestication of barracuda; however, the method only ensures the survival rate of barracuda at first-level domestication, and in the second and third domestication process, the survival rate is not ideal. Based on this, providing a convenient and high-survival freshwater domestication method for marine barracuda is a urgent technical problem that the technical personnel in this field need to solve.

### SUMMARY OF THE INVENTION

In order to solve the above technical problems, the present invention provides an ecological culture method for fish that contains marine barracuda; mixing marine barracuda with freshwater fish is able to improve economic efficiency while realizing the environmental protection benefits of low sewage discharge with aquaculture water at the same time.

An ecological culture method for fish that contains marine barracuda is characterized by the following steps:

(1) Place the marine barracuda fry in natural seawater, use circulating water to dilute the natural sea water step by step, and domesticate the marine barracuda with fresh water;

(2) When the salinity of the water body is reduced to 3‰, transfer the marine barracuda fry to the fish culturing pond, and then the freshwater species are introduced, which carries out the ecological culturing and ecological poly-culture model;

(3) During the culturing period, check the growth of barracuda, adjust the feeding and/or feeding times, so that barracuda reaches the required specifications within the expected time to be on the market.

Preferably, in step (1) as described, barracuda delivery density is 500-800 tails/m3.

Preferably, in step (1) as described, the specific process of diluting natural seawater by step using recycled water includes: use circular water to domesticate the swimming direction of fries, screen out the individuals who swim irregularly, and maintain the circular flow of water in the system during the culturing process.

Preferably, the swimming direction of fries are domesticated by using the circular flow formed by the flow of water injected into the direction of the tangent in the circular culture system, and screen out irregularly swimming individuals after three days of domestication; when the salinity of water body is greater than 6‰, the daily decrease of salinity is not higher than 1‰, and after the water salinity is less than 6‰, the daily decrease of water salinity is 1-1.5‰.

Preferably, the water flow rate is 2-5 m/min.

Preferably, in step (1), when the salinity of the water is 8-12‰, the food fed is zooplankton, or the food fed consists of zooplankton with a weight ratio of 80±5% and soy milk with a weight ratio of 20±5%; when the salinity of the water body is 6-7‰, the food fed is soy milk; when the salinity of the water is less than 2‰, the food fed is soy milk or the food fed consists of soy milk with a weight ratio of 80±5% and a feed of particles with a weight ratio of 20±5%.

Preferably, the ecological mix and combination described in step (2) is a combination of domesticated barracudas, filtered fish and other fish, and the other fish that described is ichthyophagy and/or fatty water fish; the filtered fish is chub and/or bighead carp; The ichthyophagy is one of the herring, grass carp, carp, bream or its combination; fatty water fish is Carassius auratus and/or Oreochromis mossambicus.

Preferably, in the ecological mixed culturing match, the paired fish is barracuda, chub and bighead carp; the stocking volume of barracuda accounted for 30±10% wt of total stocking, and the weight ratio of chub and bighead carp's stocking ratio is 3 to 4:1;

Preferably, the ecological mixed culturing match consists of barracuda, Carassius auratus, chub and bighead carp, and among them, Carassius auratus is the main fish, barracuda, ichthyophagy and bighead carp are paired fish; Carassius auratus contains gibel carp; the stocking volume of the Carassius auratus accounts for 60 to 70% wt of total stocking, and the stocking volume of the barracuda accounts for 30±10 wt of total stocking. The stocking volume of ichthyophagy and bighead carp occupies the remainder of the total stocking capacity, and the ratio of chub to bighead carp is 3˜4:1.

Preferably, in the ecological mix and combination, one fish or two kinds of fish are mainly culturing fish, with the rest of the fish as the paired culturing fish; the stocking volume of the mainly culturing fish shall be 60 to 70% wt of the total stocking quantity; in the ecological mixed culturing match, the average specification of each fish at stocking is 90 to 150 g.

Preferably, in step (2), oxygenation equipment is provided in the fish culture pond; the unit of mass is calculated by servings, and the main components of feed are: 31.51 servings of crude protein, 6.56 servings of crude fat, 15.00 servings of coarse ash, 1.52 servings of calcium, 1.05 servings of total phosphorus, 1.75 servings of lysine, 12.87 servings of crude fiber, 1.02 servings of salt, 12.49 servings of water.

Compared with the prior technology, the present invention has the following beneficial effects:

(1) The invention manages to realize the process of fasting domestication of barracuda in a short period of time by circulating water desalination method, and achieve a fries survival rate of up to 98%, and is able to be put into follow-up mixed culturing after the completion of domestication; at the same time, using the circular water flow formed by the direction of the tangent in the circular culture system to domesticate the swimming directions of fries, remove unhealthy individuals that swim irregularly, and maintain a circular flow rate during culturing, which helps effectively improve the culturing density.

(2) The ecological mix and culturing match defined by the invention can not only effectively improve the economic benefits of mu production, but also successfully reduce the amount of nitrogen and phosphorus environmental load, efficiently improve the utilization rate of feed nitrogen and phosphorus and reduce the bait coefficient, usefully improve the bottom sediment of ponds and effectively reduce the amount of wastewater discharge from aquaculture, ensure that the economic efficiency is improved and at the same time achieve the environmental benefits of low sewage from aquaculture water.

(3) The invention is able to mix the marine barracuda with freshwater fish, and not only can effectively reduce the environmental load of nitrogen and phosphorus, improve the utilization rate of feed nitrogen and phosphorus and reduce the bait coefficient, and also is capable to effectively improve the economic efficiency of mu production, and ensure the economic efficiency is improved while at the same time achieving the environmental benefits of low sewage from aquaculture water.

### DETAILED DESCRIPTION OF THE INVENTION

A variety of exemplary embodiments of the present invention are described in detail, the detailed description should not be regarded as a limitation of the present invention, but should be understood as a more detailed description of certain aspects of the present invention, characteristics and embodiments.

It should be understood that the terms described in the present invention are merely to describe a particular embodiment and are not intended to limit the present invention. In addition, for the range of values in the present invention, it should be understood that each median value between the upper and lower limits of the range is also specifically disclosed. The median value within any statement value or statement range, as well as any other stated value, or each smaller range between the median values in the described range, is also included in the present invention. These smaller ranges of upper and lower limits can be separately included or excluded.

Unless otherwise noted, all technical and scientific terms used herein have the same meaning as those normally understood by conventional technicians in the field described in the present invention. Even though the present invention only describes the preferred method and material, in the embodiment or test of the present invention may also use similar to or equivalent to any method and material described herein. All documents referred to in this description are referenced and incorporated to disclose and describe methods and/or materials relating to the documents in question. In the event of a conflict with any incorporated literature, the contents of this description shall prevail.

Without departing from the scope or spirit of the present invention, a variety of improvements and changes are be able to be made to the specific embodiment of the description of the present invention, which is obvious to the skilled people within the field. Other embodiments obtained from the description of the present invention are obvious to the technician. This application description and embodiment are to be exemplary only.

The words “contains,” “includes,” “has,” “consists of” etc. used in this article, are open terms that mean, contain, but are not limited to.

### Embodiment 1 Domestication of the Marine Barracuda by Fresh Water

Select the marine barracuda fry and place them in a circular culture system that contains natural seawater (12% salinity) with a drop density of 800 tails/m3, open the circulating water system, use the circular water flow formed by the line injection into the circular line in the circular culture system to domesticate the swimming directions of the fries, and after three days of domestication, screen out irregularly swimming individuals, and the water flow speed should be controlled at 4 m/min; first of all, gradually reduce the salinity of water body at the rate of 0.5%/day, and when water salinity reaches 10%, gradually reduce the salinity of water body at the rate of 0.8%/day; after the water salinity reaches 8%, the water salinity is gradually reduced at the rate of 1%/day, and after the water salinity reaches 6%, the water salinity is gradually reduced at 1.5%/day, until the water salinity reaches 2-3%, and after one day's stabilized water salinity to obtain freshwater-domesticated barracuda.

After the above-mentioned domestication process, the survival rate of the marine barracuda is 98%.

### Embodiment 2

Similar to embodiment 1, and the difference is that the freshwater domestication process gradually reduces the salinity of the water body at a rate of 1%/day until the water salinity reaches 2-3%.

After the above-mentioned domestication process, the survival rate of the marine barracuda is 95%.

### Embodiment 3

Similar to embodiment 1, use graded freshwater domestication for barracuda domestication, specifically, 12% natural sea water for 1 day, transfer to 10% diluted sea water domestication for 1 day, 8% diluted sea water domestication for 1 day, 6% diluted sea water domestication for 1 day, 4% diluted sea water domestication for 1 day, 3% diluted sea water domesticated for 1 day, and then obtain freshwater-domesticated barracuda.

After the above-mentioned domestication process, the survival rate of the marine barracuda is 82%.

### Embodiment 4

Similar to embodiment 1, and the difference is that the three-level freshwater domestication method of barracuda domestication is utilized, specifically, the salinity of primary desalination water body is 10%, the salinity of second-level desalination water body is 7%, the salinity of third-level desalination water body is 3%, and the dilution time at all levels is 3 days.

After the above-mentioned domestication process, the survival rate of the marine barracuda is 75%.

Embodiment 5 Ecological mixing combination of large culturing ponds.

Six culture models are utilized for comparative testing under the same condition, and barracuda is the barracuda that domesticated and diluted in embodiment 1, and six culture models are as follows (percentage for stocking ratio):

T1, 100% gibel carp;

T2, 80% gibel carp and 20% chub, bighead carp (quality ratio of 3:1);

T3, 100% barracuda;

T4, 80% gibel carp and 20% barracuda;

T5, 60% gibel carp and 30% barracuda, 10% chub, big head carp (3:1);

T6, 68% gibel carp, 8% grass fish, 15% chub, and 9% bighead carp.

Among them, the T5 model belongs to the culture model of the present invention.

The total stocking amount of species is 2000 kg/hm2. The average specifications per tail are: gibel carp 120±3.5 g, chub 100 g±2.5 g, bighead carp 110±3.5 g, barracuda 120±4.5 g, grass carp 90±3.0 g.

The culturing period is from April to November, with a total feed of 25,178 kg per pond.

Feed ingredients are followings: 31.51 servings of crude protein, 6.56 servings of coarse fat, 15.00 servings of coarse ash, 1.52 servings of calcium, 1.05 servings of total phosphorus, 1.75 servings of lysine, 12.87 servings of crude fiber, 1.02 servings of salt, and 12.49 servings of water.

During the culturing period, the opening of aerator is determined according to the condition of fish activity, with each pond opening 720 h.

Within the first 30 d of culture, do not change water, and depending on the evaporation or leakage of water, a small amount of water is replenished in moderation and the water depth is maintained at a depth of about 1.8 m. During the culturing period and the later stage of culturing, utilizing the continuing approach to gradually increase the water exchange, and the average daily change of water is about 1.5%. Precipitation needs to reach 8500 mm and sunshine hours should be achieved for 1325 h.

Experimental Results:

After examining the nitrogen and phosphorus environmental load of each culture model and the utilization rate of feed nitrogen and phosphorus, the net increase in production is shown in Table 1;

TABLE 1

| | Nitrogen | Phosphorus | Nitrogen | phosphorus | |
|---|---|---|---|---|---|
| | environ- | environ- | feed | feed | Profit/ |
| | mental | mental | utilization, | utilization | mu, |
| | load, kg/t | load, kg/t | % | rate, % | yuan |
| T1 | 70 | 18 | 24 | 13 | 2200 |
| T2 | 55 | 15 | 32 | 17 | 2510 |
| T3 | 73 | 18 | 26 | 15 | 2500 |
| T4 | 51 | 14 | 30 | 20 | 2715 |
| T5 | 45 | 12 | 35 | 22 | 3700 |
| T6 | 50 | 15 | 30 | 19 | 2910 |

It can be obtained from the results that the mixed culture model of the present invention makes full use of the ecological complementarities of barracuda and other fish, prolongs the food chain, improves feed utilization rate, and enhances yield and economic benefits.

Comparing the state of the pond bottom of the culture model, the results are shown in Table 2;

TABLE 2

| | Bottom Sediment Condition | | | |
|---|---|---|---|---|
| | Bottom | Organic | | |
| | sediment | compounds | TN | TP |
| | thickness (cm) | (g/kg) | (g/kg) | (g/kg) |
| T1 | 5.80 | 25.11 | 2.55 | 2.16 |
| T2 | 5.75 | 21.50 | 2.19 | 2.11 |
| T3 | 6.32 | 25.35 | 2.76 | 2.29 |
| T4 | 4.30 | 21.58 | 2.15 | 2.04 |
| T5 | 4.20 | 18.15 | 1.89 | 1.76 |
| T6 | 5.21 | 22.49 | 2.25 | 2.15 |

Comparing the amount of wastewater discharge from each culture model, the results are shown in Table 3;

TABLE 3

| | Amount of sewage from aquaculture wastewater | | | |
|---|---|---|---|---|
| | TN (kg/hm²) | TP (kg/hm²) | COD (kg/hm²) | SS (kg/hm²) |
| T1 | 211.50 ± 7.50 | 15.25 ± 0.59 | 615.51 ± 22.18 | 6158.20 ± 25.18 |
| T2 | 155.01 ± 8.04 | 10.45 ± 0.85 | 457.15 ± 20.08 | 5179.85 ± 22.15 |
| T3 | 236.15 ± 8.15 | 16.49 ± 1.25 | 846.78 ± 25.19 | 7419.15 ± 19.52 |
| T4 | 168.19 ± 5.46 | 12.54 ± 1.59 | 520.48 ± 22.19 | 5514.49 ± 15.49 |
| T5 | 125.78 ± 6.15 | 8.45 ± 8.45 | 443.85 ± 12.11 | 5019.11 ± 20.49 |
| T6 | 149.85 ± 5.25 | 11.25 ± 0.59 | 459.45 ± 5.19 | 5649.41 ± 15.86 |

From Table 2 and Table 3 can be concluded that the mixed culture model of the present invention is able to maintain the stability of the water quality of the pond, and alleviate the problem of low discharge of aquaculture tail water.

The above is only a better embodiment of the present invention and is not intended to limit the present invention; any modification, equivalent substitution and improvement, etc. made within the spirit and principles of the present invention shall be included within the scope of protection of the present invention.

1. An ecological culture method for fish that contains marine barracuda, which is characterized by the following steps:
(1) Place the marine barracuda fry in natural seawater, dilute natural seawater step by step with recycled water, domesticate marine barracuda by fresh water;
(2) When the salinity of the water body is reduced to 3‰, transfer the marine barracuda fry to the fish culturing pond, and then the freshwater species are introduced, which carries out the ecological culturing and ecological poly-culture model;
(3) During the culturing period, check the growth of barracuda, adjust the feeding and/or feeding times, so that barracuda reaches the required specifications within the expected time to be on the market.

2. According to the ecological culture method for fish that contains marine barracuda that described in claim 1, it is characterized by a density of 500-800 tails/m3 in the step (1).

3. According to the ecological culture method for fish that contains marine barracuda described in claim 1, it is characterized by the fact that in the step (1), the specific process of diluting natural seawater by step using recycled water includes: use circular water to domesticate the swimming direction of fries, screen out the individuals who swim irregularly, and maintain the circular flow of water in the system during the culturing process.

4. According to the ecological culture method for fish that contains marine barracuda described in claim 3, its characteristics are that the swimming direction of fries are domesticated by using the circular flow formed by the flow of water injected into the direction of the tangent in the circular culture system, and screen out irregularly swimming individuals after three days of domestication; when the salinity of water body is greater than 6‰, the daily decrease of salinity is not higher than 1‰, and after the water salinity is less than 6‰, the daily decrease of water salinity is 1-1.5‰.

5. According to the ecological culture method for fish that contains marine barracuda described in claim 3, it is characterized by a water flow rate of 2-5 m/min.

6. According to the ecological culture method for fish that contains marine barracuda described in claim 1, it is characterized by the fact that in step (1), when the salinity of the water is 8-12‰, the food fed is zooplankton, or the food fed consists of zooplankton with a weight ratio of 80±5% and soy milk with a weight ratio of 20±5%; when the salinity of the water body is 6-7‰, the food fed is soy milk; when the salinity of the water is less than 2‰, the food fed is soy milk or the food fed consists of soy milk with a weight ratio of 80±5% and a feed of particles with a weight ratio of 20±5%.

7. The ecological culture method for fish that contains marine barracuda, as described in claim 1, is characterized by the ecological mix and combination described in step (2) as a combination of domesticated barracudas, filtered fish and other fish, and the other fish that described is ichthyophagy and/or fatty water fish; the filtered fish is chub and/or bighead carp; the ichthyophagy is one of the herring, grass carp, carp, bream or its combination; fatty water fish is Carassius auratus and/or Oreochromis mossambicus.

8. According to the ecological culture method for fish that contains marine barracuda described in claim 7, its characteristics are that in the ecological mix and combination, one fish or two kinds of fish are mainly fish, with the rest of the fish as the paired fish; the stocking volume of the main fish shall be 60 to 70% wt of the total stocking quantity; in the ecological mixed culturing match, the average specification of each fish at stocking is 90 to 150 g.

9. The ecological culture method for fish that contains marine barracuda described in claim 1 is characterized by the addition of oxygenation equipment in the fish culturing pond in the step (2); the unit of mass is calculated by servings, and the main components of feed are: 31.51 servings of crude protein, 6.56 servings of crude fat, 15.00 servings of coarse ash, 1.52 servings of calcium, 1.05 servings of total phosphorus, 1.75 servings of lysine, 12.87 servings of crude fiber, 1.02 servings of salt, 12.49 servings of water.
